(19) United States
(12) Patent Application Publication
(10) Pub. No.: US 2004/0233670 A1
(43) Pub. Date: Nov. 25, 2004

(54) Spotlight with pressure regulating device

(76) Inventor: Kenneth J. Linde, Industry, CA (US)

Correspondence Address: Raymond Y. Chan, Suite 128, 108 N. Ynez Ave., Monterey Park, CA, 91754, US

(21) Appl. No.: 10/443,455

(22) Filed: May 21, 2003

(51) Int. Cl. F21V 29/00

(52) U.S. Cl. 362/267; 362/310

(57) ABSTRACT

A spotlight which includes a sealing casing having an interior chamber defining an illumination cavity and a battery compartment communicating with the illumination cavity, a rechargeable battery disposed in the battery compartment of the sealing casing, and an illuminator electrically connected the rechargeable battery for producing a projecting light. A pressure regulating valve is mounted on the sealing casing to communicate with the interior chamber for regulating an interior pressure thereof in equilibrium with respect to an atmosphere pressure. Therefore, when the interior pressure of the sealing casing is larger than the atmosphere pressure, the pressure regulating valve opens for releasing the interior pressure within the interior chamber until the interior pressure reaches the atmosphere pressure.

### BACKGROUND OF THE PRESENT INVENTION

1. Field of Invention

The present invention relates to a spotlight, and more particularly to a spotlight with a pressure regulating device which is adapted to discharge the gas, such as noxious gas formed by the chemical reaction of the rechargeable battery, so as to adjustably regulate the pressure within the casing of the spotlight.

2. Description of Related Arts

Portable lights, such as torches or spotlights have long been widely used for outdoors or emergency illumination. The reasons for their popularity are that they are convenient, inexpensive, and most importantly, extremely useful, especially when no other illuminating means is available.

These advantages do not however, undermine the various general disadvantages of the traditional spotlight or torches. Perhaps the first of which is inherent from the very advantage of those spotlights, that is, their high portability. As a matter of fact, traditional spotlights or torches are designed for outdoors use, as a result, they are made as light as possible and as small as possible.

The distinctive feature of such spotlight is to provide a waterproof ability wherein the connecting edges of the casing of the spotlight are sealed to prevent the water entering into the casing such that the spotlight is considered as one of the important sport equipment during outdoor activities such as fishing or boating.

However, due to the chemical reaction, the rechargeable battery disposed inside the casing releases noxious gas such that the pressure within the sealed casing will be gradually increased. Therefore, the casing will be cracked once the interior pressure of the casing is higher than the atmosphere pressure. It is impractical to open the casing to release the pressure therein since the casing may loss the meaning of waterproof feature when the casing is opened. Moreover, due to the weight of the spotlight, the spotlight will sink in the water even though the spotlight is waterproofed.

In addition, the spotlight does not usually have an additional stand attached thereon. There are some spotlights which comprise a fluorescent lamp attached thereon for prolonged illumination. However, almost all of them utilize one of their surfaces, such as the bottom surface, as a stand to support the whole spotlight. Consequently, their potential applications are limited just simply because of their inflexible ‘stands’.

Of course, from engineering point of view, an additional stand could be easily attached on the spotlight in order to provide a more flexible support. However, at the same time the stand is added on, the spotlight will become heavier, and possibly, more bulky. This problem directly affects the core application of the spotlight which is certainly undesirable.

Another problem of traditional spotlights or torches are the inflexibility of illumination. This is so even for some spotlights which comprise more than one illumination units, such as one high-intensity halogen light-bulb and one fluorescent lamp. The main problem is that no matter how many illuminating units they have, each of them is designed to provide illumination in a distinct, often opposite, direction.

### SUMMARY OF THE PRESENT INVENTION

A main object of the present invention is to provide a spotlight with a pressure regulating device which is adapted to discharge the gas, such as noxious gas formed by the chemical reaction of the rechargeable battery, so as to adjustably regulate the pressure within the sealing casing of the spotlight.

Another object of the present invention is to provide a spotlight with a pressure regulating device, wherein the spotlight is waterproof so as to suit different environmental circumstances in which it is used, especially during outdoor activities such as fishing or boating.

Another object of the present invention is to provide a spotlight with a pressure regulating device, wherein the pressure regulating device is adapted to retain a predetermined interior pressure inside the sealing casing so as to form an air chamber therein so that the spotlight is capable of floating on the water.

Another object of the present invention is to provide a spotlight with a pressure regulating device, wherein the pressure regulating device comprises a pressure discharging valve communicating with the interior chamber for automatically discharging the gas from the interior chamber to outside. Therefore, once the interior pressure of the sealing casing is larger than the atmosphere pressure, the pressure discharging valve automatically opens to release the interior pressure until the interior pressure reaches the atmosphere pressure.

Another object of the present invention is to provide a spotlight with a pressure regulating device, wherein the rechargeable battery is supported at a rear portion of the sealing casing in such a manner that the center of mass of the spotlight shifts apart from the illumination unit of the spotlight. Therefore, when the spotlight floats on the water, the illumination unit is inclinedly positioned above the water so as to provide a slanted projecting angle with respect to the water level.

Another object of the present invention is to provide a spotlight with a pressure regulating device, wherein the spotlight further comprises an extendable stand which is adapted to extend to provide secure support to the spotlight when necessary, wherein the extendable stand is also capable of being curtailed for easy carrying.

Another object of the present invention is to provide a spotlight with a pressure regulating device, wherein the spotlight further comprises an auxiliary illuminator so as to widen the scope of application of the spotlight and to provide auxiliary illumination from the main illuminator of the spotlights.

Another object of the present invention is to provide a spotlight with a pressure regulating device, wherein the extendable stand and the auxiliary illuminator do not significant affect the original structure, weight and overall size of the spotlight so as to reduce the manufacturing and related cost thereof and to increase the desirability of utilization of the present invention.

Accordingly, in order to accomplish the above objects, the present invention provide a spotlight, comprising:

a sealing casing having an interior chamber defining an illumination cavity and a battery compartment communicating with the illumination cavity, wherein the sealing casing has waterproof ability for preventing water from entering into the interior chamber;

a power supplying unit comprising a rechargeable battery disposed in the battery compartment of the sealing casing;

an illumination unit, which is sealedly disposed in the illumination cavity, comprising an illuminator electrically connected the rechargeable battery for producing a projecting light; and

a pressure regulating valve mounted on the sealing casing to communicate with the interior chamber for regulating an interior pressure thereof in equilibrium with respect to an atmosphere pressure in such a manner that when the interior pressure of the sealing casing is larger than the atmosphere pressure, the pressure regulating valve opens for releasing the interior pressure within the interior chamber until the interior pressure reaches the atmosphere pressure.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a spotlight with a pressure regulating device according to a preferred embodiment of the present invention.

FIG. 2 is an exploded perspective view of the spotlight with the pressure regulating device according to the above preferred embodiment of the present invention.

FIG. 3 is a sectional view of the spotlight with the pressure regulating device according to the above preferred embodiment of the present invention.

FIG. 4 is a schematic diagram of the extendable supporting frame of the spotlight between its standing position and idle position according to the above preferred embodiment of the present invention.

FIG. 5 is a perspective view of the spotlight according to the above preferred embodiment of the present invention, illustrating an angle being formed between the projecting light and the water level when the spotlight floats on the water.

### DETAILED DESCRIPTION OF THE PREFERRED EMBODIMENT

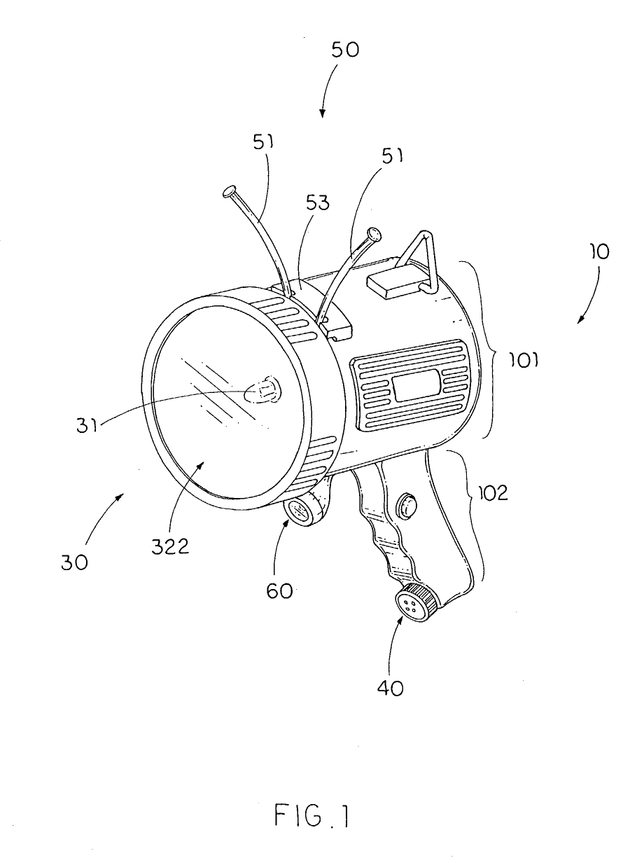

Referring to FIGS. 1 to 3 of the drawings, a spotlight according to a preferred embodiment of the present invention is illustrated, wherein the spotlight comprises a sealing casing 10 having an interior chamber 11 defining an illumination cavity 111 and a battery compartment 112 communicating with the illumination cavity 111, wherein the sealing casing 10 has waterproof ability for preventing water from entering into the interior chamber 13.

The spotlight further comprises a power supplying unit 20 comprising a rechargeable battery 21 disposed in the battery compartment 112 of the sealing casing 10 and an illumination unit 30, which is sealedly disposed in the illumination cavity 111, comprising an illuminator 31 electrically connected the rechargeable battery 21 for producing a projecting light.

The spotlight further comprises a pressure regulating valve 40 mounted on the sealing casing 10 to communicate with the interior chamber 13 for regulating an interior pressure thereof in equilibrium with respect to an atmosphere pressure in such a manner that when the interior pressure of the sealing casing 10 is larger than the atmosphere pressure, the pressure regulating valve 40 opens for releasing the interior pressure within the interior chamber 13 until the interior pressure reaches the atmosphere pressure.

The sealing casing 10 is constructed to have a main body 101, preferably having a circular cross section, and a handle frame 102 downwardly and integrally extended from the main body 101, wherein the illumination cavity 111 is formed at a front portion of the main body 101 and the battery compartment 112 is formed at a rear portion of the main body 101 in such a manner that when the rechargeable battery 21 is disposed in the battery compartment 112, a center of mass of the spotlight shifts towards the rear side thereof.

The illumination unit 30 further comprises a waterproof illuminating holder 32 having a concave reflecting surface 320 and a sealing element 33 sealedly mounted the illuminating holder 32 to the sealing casing 10 within the illuminating cavity 111 for preventing water entering to the illuminating cavity 111, wherein the illuminator 31 is supported at a focus point of the reflecting surface 320 of the illuminating holder 32 for providing the projecting light.

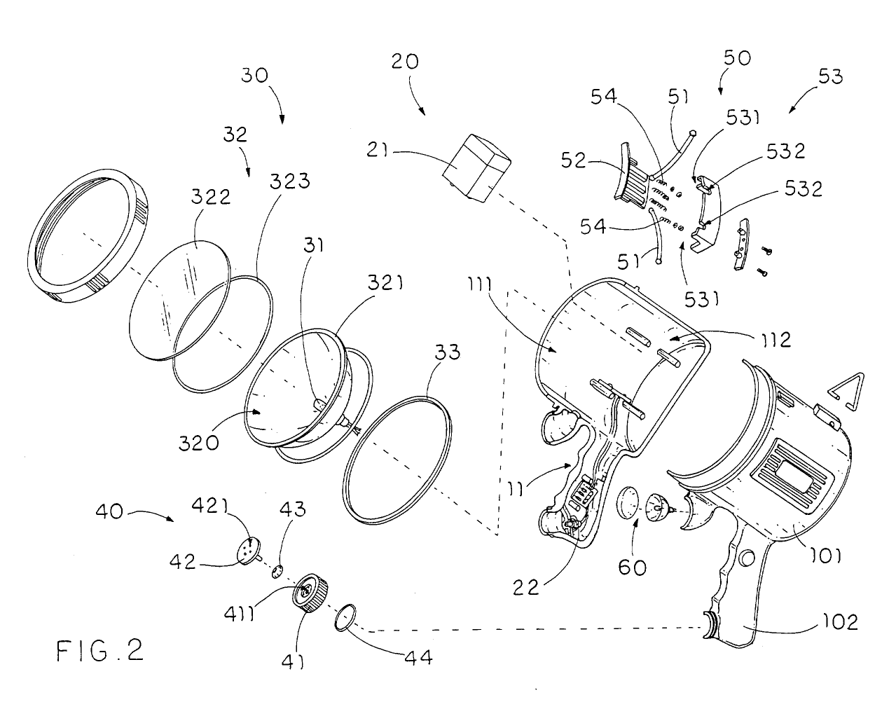

As shown in FIG. 2, the illuminator 31 is preferably embodied as a high intensity halogen light for providing strong and high intensity illumination in a predetermined direction. Alternatively, the illuminator 31 can be a replaceable light bulb supported at the focus point the reflecting surface 320 of the illuminating holder 32 to electrically connect with the rechargeable battery 21.

The illuminating holder 32 comprises a cone shaped holder member 321 defining an inner circumferential surface as the reflecting surface 320 and an illuminating lens 322 sealedly mounted to the holder member 321 via a sealing ring 323 to protect the illuminator 31 within the holder member 321 in a water sealed manner in such a manner that the light from the illuminator 31 is arranged to reflect on the reflecting surface 320 of the holder member 321 to maximize the intensity of illumination projecting out of the illuminating cavity 111 through the illuminating lens 322 to form the projecting light.

The sealing element 33 is embodied as a sealing ring peripherally mounted along the circumferential edge of the illuminating holder 32 with an opening of the illumination cavity 111 of the sealing casing 10 so as to seal a gap formed between the illuminating holder 32 and the sealing casing 10 for preventing water from entering into the interior chamber 11 of the sealing casing 10.

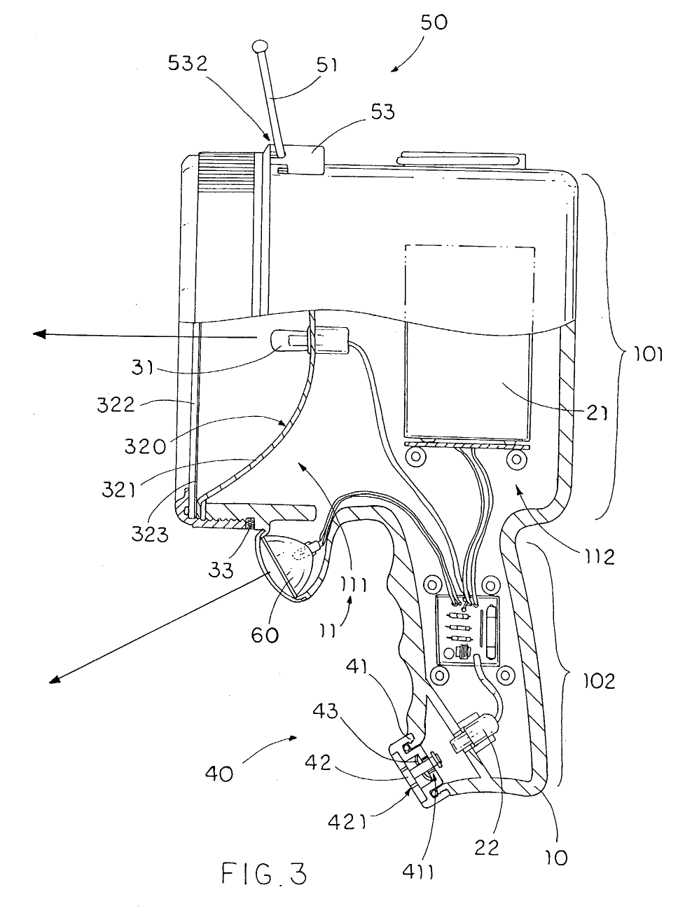

The pressure regulating valve 40, according to the preferred embodiment, is a one-way gas valve mounted on the sealing casing 10 to communicate with the interior chamber 11. As shown in FIG. 3, the pressure regulating valve 40 comprises a valve body 41 having a plurality of gas releasing meshes 411, a valve actuator 42, having a plurality of gas discharging meshes 421, movably mounted to the valve body 41, and a valve stopper 43 mounted between the valve body 41 and the valve actuator 42 to normally seal the gas releasing meshes 411 for preventing the interior pressure releasing therefrom, wherein the valve stopper 43 is arranged to be pushed towards the valve actuator 42 for releasing the interior pressure from the gas releasing meshes 411 to outside through the gas discharging meshes 421 when the interior pressure of the sealing casing 10 is larger than the atmosphere pressure.

Accordingly, when the atmosphere pressure is larger than the interior pressure of the sealing casing 10, the atmosphere pressure normally pushes the valve stopper 43 towards the valve body 41 to seal the gas releasing meshes 411 in a water tight manner so as to retain the interior pressure of the sealing casing 10 below a safety pressure. Once the interior pressure is larger than the atmosphere pressure, the interior pressure will substantially release through the gas releasing meshes 411 of the valve body 41 and will strong enough to push the valve stopper 43 towards the valve actuator 42 so as to push the valve actuator 42 offset to the valve body 41 for releasing the interior pressure to outside through the gas discharging meshes 421.

It is worth to mention that a diameter of each of the gas releasing meshes 411 should be equal to that of each of the gas discharging meshes 421. In addition, the number of the gas releasing meshes 411 should be more than the number of the gas discharging meshes 421 in such a manner that the interior pressure is jetting out of the valve actuator 42 through the gas discharging meshes 421 so as to enhance the interior pressure releasing from the interior chamber 11 of the sealing chamber 10. In other words, a volume of gas released through the gas releasing meshes 411 is larger than a volume of gas released through the gas discharging meshes 421 so as to form a flow of gas jetting out of the gas discharging meshes 421 of the valve actuator 42.

As it is mentioned in the background, the rechargeable battery 21 produces noxious gas due to the chemical reaction of the rechargeable battery 21. Therefore, the interior pressure of the sealing casing 10 will be gradually increased so as to damage the illumination unit 30 and even crack the sealing casing 10. As a result, the noxious gas can be released through the pressure regulating valve 40 to balance the interior pressure with respect to the atmosphere pressure.

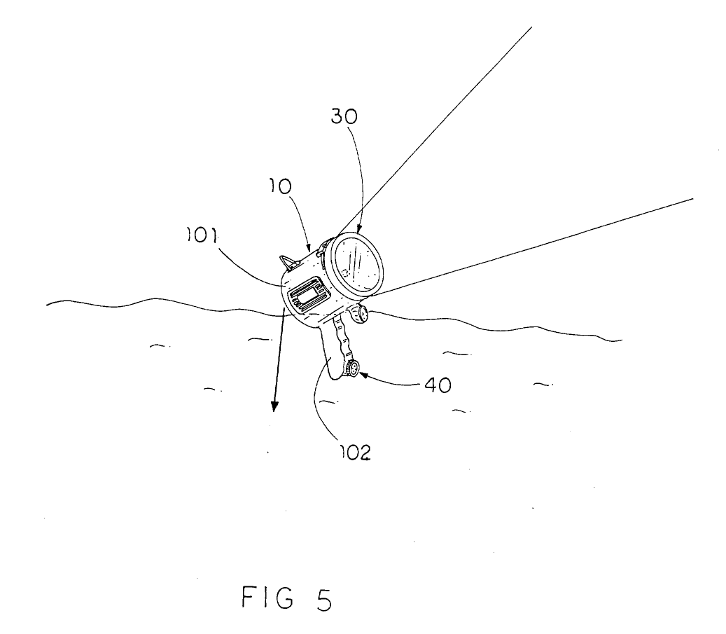

In accordance with the configuration of the spotlight of the present invention, when the noxious gas is generated within the sealing casing 10, the interior chamber 11 of the sealing casing 10 functions as an air chamber such that the waterproof spotlight is capable of floating on the water. Since the center of mass of the spotlight shifts towards the rear portion thereof, the spotlight is inclinedly floating on the water such that the projecting light of the spotlight projects with an angle with respect to the water level, as shown in FIG. 5. Therefore, the user is able to put the spotlight to float on the water for illumination purpose.

As shown in FIG. 3, the power supplying unit 20 further comprise a charging inlet 22 mounted on the sealing casing 10 at a position behind the pressure regulating valve 40 wherein the pressure regulating valve 40 is detachably mounted on the sealing casing 10 in such a manner that the rechargeable battery 21 is capable of electrically connecting to a power source through the charging inlet 22 when the pressure regulating valve 40 is detached from the sealing casing 10. It is worth to mention that while recharging the rechargeable battery 21, the rechargeable battery 21 produces more noxious gas than usual using state. Therefore, the noxious gas can be directly released from the interior chamber 11 of the sealing casing 10 to outside when the rechargeable battery 21 is recharging.

A sealing ring 44 should be used to mount around the pressure regulating valve 40 with the sealing casing 10 so as to seal the gap between the pressure regulating valve 40 and the sealing casing 10 for preventing the water from entering into the interior chamber 11 of the sealing casing 10 to damage the charging inlet 22.

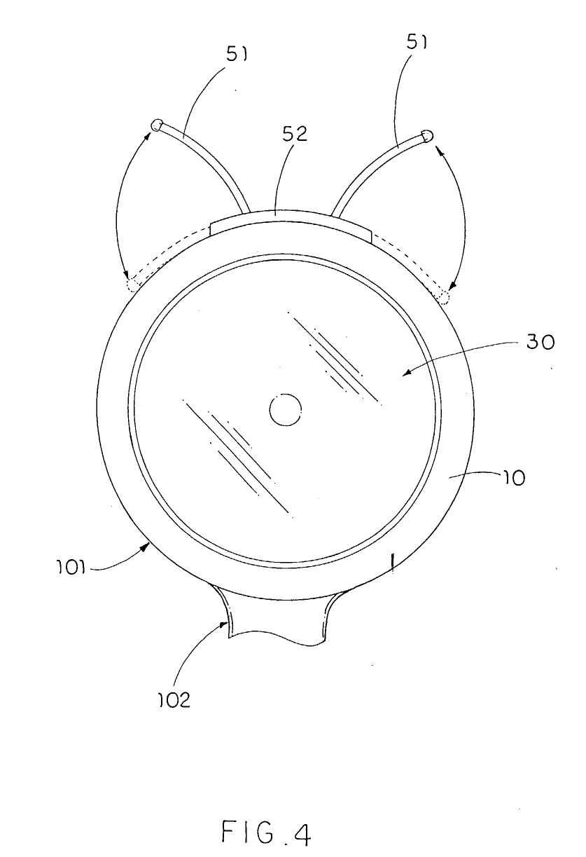

Referring to FIG. 2 of the drawings, the spotlight further comprises an extendable supporting frame 50 comprises a pair of standing legs 51 pivotally and sidewardly extended on top of the sealing casing 10 to fold between a standing position and a storage position, wherein at the standing position, the standing legs 51 are pivotally folded apart from the sealing casing 10 to support the sealing casing 10 in an up-side-down manner, and at the storage position, the standing legs 51 are pivotally folded to align on an outer circumferential surface of the sealing casing 10, as shown in FIG. 4.

According to the preferred embodiment, each of the standing legs 51, having an arc shaped, has a curvature corresponding to a curvature of the outer circumferential surface of the sealing casing 10 in such a manner that the standing legs 51 are fittingly aligned on the outer circumferential surface of the sealing casing 10 at the storage position.

The extendable supporting frame 50 further comprises a supporting base 52 mounted on the outer circumferential surface of the sealing casing 10 to pivotally connect the two standing legs 51 and a slider hub 53 slidably mounted on the supporting base 52, wherein the slider hub 53 has two side retaining slots 531 for respectively holding the standing legs 51 therein at the storage position and two upper retaining slots 532 for respectively holding the standing legs 51 therein at the standing position.

The extendable supporting frame 50 further comprises a plurality of resilient elements 54 which are preferably a plurality of coil springs mounted on the supporting base 52 for applying an urging pressure against the standing legs 51 respectively so as to normally retain the supporting stands 32 in the storage position.

In order to operate the extendable supporting frame 50, the user is able to rearwardly slide the slider hub 52 on the supporting base 52 such that the standing legs 51 are capable of upwardly folding from the outer circumferential surface of the sealing casing 10. Then, by forwardly sliding the slider hub 53 back to its original position, the standing legs 51 are respectively retained within the upper retaining slots 532 of the slider hub 53 so as to retain the standing legs 51 at the standing position. Therefore, the spotlight is adapted to be supported on the ground in an up-side-side manner through the standing legs 51 so as to provide the projecting light with an angle with respect to the ground level.

Referring to FIG. 3 of the drawings, in order to further enhance the range of applications of the present invention, the spotlight further comprises an auxiliary illumination unit 60 which is electrically connected to the rechargeable battery 21 and is sealedly mounted on the sealing casing 10 at a position underneath the illumination unit 30 for providing an auxiliary projecting light at an angle A with respect to the projecting light. As such, the auxiliary illumination unit 60 is capable of providing auxiliary illumination in addition to the illumination unit 30 so as to suit different needs in different circumstances where additional auxiliary illumination at a particular orientation is desirable.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure form such principles. Therefore, this invention includes all modifications encompassed within the spirit and scope of the following claims.

What is claimed is:

1. A spotlight, comprising:
a sealing casing having an interior chamber defining an illumination cavity and a battery compartment communicating with said illumination cavity, wherein said sealing casing has waterproof ability for preventing water from entering into said interior chamber;
a power supplying unit comprising a rechargeable battery disposed in said battery compartment of said sealing casing;
an illumination unit, which is sealedly disposed in said illumination cavity, comprising an illuminator electrically connected said rechargeable battery for producing a projecting light; and
a pressure regulating valve mounted on said sealing casing to communicate with said interior chamber for regulating an interior pressure thereof in equilibrium with respect to an atmosphere pressure in such a manner that when said interior pressure of said sealing casing is larger than said atmosphere pressure, said pressure regulating valve opens for releasing said interior pressure within said interior chamber until said interior pressure reaches said atmosphere pressure.

2. The spotlight, as recited in claim 1, wherein said pressure regulating valve comprises a valve body having a plurality of gas releasing meshes, a valve actuator, having a plurality of gas discharging meshes, movably mounted to said valve body, and a valve stopper mounted between said valve body and said valve actuator to normally seal said gas releasing meshes for preventing said interior pressure releasing therefrom, wherein said valve stopper is arranged to be pushed by said interior pressure towards said valve actuator for releasing said interior pressure from said gas releasing meshes to outside through said gas discharging meshes when said interior pressure of said sealing casing is larger than said atmosphere pressure.

3. The spotlight, as recited in claim 2, wherein a diameter of each of said gas releasing meshes is equal to that of each of said gas discharging meshes, wherein a number of said gas releasing meshes is more than a number of said gas discharging meshes for jetting said interior pressure out of said valve actuator through said gas discharging meshes so as to enhance said interior pressure releasing from said interior chamber of said sealing chamber.

4. The spotlight, as recited in claim 1, wherein said power supplying unit further comprise a charging inlet mounted on said sealing casing at a position behind said pressure regulating valve, wherein said pressure regulating valve is detachably mounted on said sealing casing in such a manner that said rechargeable battery is capable of electrically connecting to a power source through said charging inlet when said pressure regulating valve is detached from said sealing casing.

5. The spotlight, as recited in claim 2, wherein said power supplying unit further comprise a charging inlet mounted on said sealing casing at a position behind said pressure regulating valve, wherein said pressure regulating valve is detachably mounted on said sealing casing in such a manner that said rechargeable battery is capable of electrically connecting to a power source through said charging inlet when said pressure regulating valve is detached from said sealing casing.

6. The spotlight, as recited in claim 3, wherein said power supplying unit further comprise a charging inlet mounted on said sealing casing at a position behind said pressure regulating valve, wherein said pressure regulating valve is detachably mounted on said sealing casing in such a manner that said rechargeable battery is capable of electrically connecting to a power source through said charging inlet when said pressure regulating valve is detached from said sealing casing.

7. The spotlight, as recited in claim 1, wherein said sealing casing is constructed to have a main body and a handle frame downwardly and integrally extended from said main body, wherein said illumination cavity is formed at a front portion of said main body and said battery compartment is formed at a rear portion of said main body in such a manner that when said rechargeable battery is disposed in the battery compartment, a center of mass of said spotlight shifts towards said rear side thereof, thereby, said sealing casing is capable of floating on a water while said illumination unit provides said projecting light at an angle with respect to a water level.

8. The spotlight, as recited in claim 4, wherein said sealing casing is constructed to have a main body and a handle frame downwardly and integrally extended from said main body, wherein said illumination cavity is formed at a front portion of said main body and said battery compartment is formed at a rear portion of said main body in such a manner that when said rechargeable battery is disposed in the battery compartment, a center of mass of said spotlight shifts towards said rear side thereof, thereby, said sealing casing is capable of floating on a water while said illumination unit provides said projecting light at an angle with respect to a water level.

9. The spotlight, as recited in claim 6, wherein said sealing casing is constructed to have a main body and a handle frame downwardly and integrally extended from said main body, wherein said illumination cavity is formed at a front portion of said main body and said battery compartment is formed at a rear portion of said main body in such a manner that when said rechargeable battery is disposed in the battery compartment, a center of mass of said spotlight shifts towards said rear side thereof, thereby, said sealing casing is capable of floating on a water while said illumination unit provides said projecting light at an angle with respect to a water level.

10. The spotlight, as recited in claim 1, further comprising an extendable supporting frame which comprises a pair of standing legs pivotally and sidewardly extended on top of said sealing casing to fold between a standing position and a storage position, wherein at said standing position, said standing legs are pivotally folded apart from said sealing casing to support said sealing casing in an up-side-down manner, and at said storage position, said standing legs are pivotally folded to align on an outer circumferential surface of said sealing casing.

11. The spotlight, as recited in claim 2, further comprising an extendable supporting frame which comprises a pair of standing legs pivotally and sidewardly extended on top of said sealing casing to fold between a standing position and a storage position, wherein at said standing position, said standing legs are pivotally folded apart from said sealing casing to support said sealing casing in an up-side-down manner, and at said storage position, said standing legs are pivotally folded to align on an outer circumferential surface of said sealing casing.

12. The spotlight, as recited in claim 6, further comprising an extendable supporting frame which comprises a pair of standing legs pivotally and sidewardly extended on top of said sealing casing to fold between a standing position and a storage position, wherein at said standing position, said standing legs are pivotally folded apart from said sealing casing to support said sealing casing in an up-side-down manner, and at said storage position, said standing legs are pivotally folded to align on an outer circumferential surface of said sealing casing.

13. The spotlight, as recited in claim 9, further comprising an extendable supporting frame which comprises a pair of standing legs pivotally and sidewardly extended on top of said sealing casing to fold between a standing position and a storage position, wherein at said standing position, said standing legs are pivotally folded apart from said sealing casing to support said sealing casing in an up-side-down manner, and at said storage position, said standing legs are pivotally folded to align on an outer circumferential surface of said sealing casing.

14. The spotlight, as recited in claim 10, wherein said extendable supporting frame further comprises a supporting base mounted on said outer circumferential surface of said sealing casing to pivotally connect said two standing legs and a slider hub slidably mounted on said supporting base, wherein said slider hub has two side retaining slots for respectively holding said standing legs therein at said storage position and two upper retaining slots for respectively holding said standing legs therein at said standing position.

15. The spotlight, as recited in claim 11, wherein said extendable supporting frame further comprises a supporting base mounted on said outer circumferential surface of said sealing casing to pivotally connect said two standing legs and a slider hub slidably mounted on said supporting base, wherein said slider hub has two side retaining slots for respectively holding said standing legs therein at said storage position and two upper retaining slots for respectively holding said standing legs therein at said standing position.

16. The spotlight, as recited in claim 12, wherein said extendable supporting frame further comprises a supporting base mounted on said outer circumferential surface of said sealing casing to pivotally connect said two standing legs and a slider hub slidably mounted on said supporting base, wherein said slider hub has two side retaining slots for respectively holding said standing legs therein at said storage position and two upper retaining slots for respectively holding said standing legs therein at said standing position.

17. The spotlight, as recited in claim 13, wherein said extendable supporting frame further comprises a supporting base mounted on said outer circumferential surface of said sealing casing to pivotally connect said two standing legs and a slider hub slidably mounted on said supporting base, wherein said slider hub has two side retaining slots for respectively holding said standing legs therein at said storage position and two upper retaining slots for respectively holding said standing legs therein at said standing position.

18. The spotlight, as recited in claim 6, further comprising an auxiliary illumination unit which is electrically connected to said rechargeable battery and is sealedly mounted on said sealing casing at a position underneath said illumination unit for providing an auxiliary projecting light at an angle with respect to said projecting light.

19. The spotlight, as recited in claim 9, further comprising an auxiliary illumination unit which is electrically connected to said rechargeable battery and is sealedly mounted on said sealing casing at a position underneath said illumination unit for providing an auxiliary projecting light at an angle with respect to said projecting light.

20. The spotlight, as recited in claim 17, further comprising an auxiliary illumination unit which is electrically connected to said rechargeable battery and is sealedly mounted on said sealing casing at a position underneath said illumination unit for providing an auxiliary projecting light at an angle with respect to said projecting light.
